(19) United States
(12) Patent Application Publication
(10) Pub. No.: US 2013/0236361 A1
(43) Pub. Date: Sep. 12, 2013

(54) HEATING COMBUSTION TUBE, PYROLYSIS APPARATUS AND MERCURY ANALYZING APPARATUS IN ANALYSIS OF MERCURY

(71) Applicants: Tomoaki Watanabe, Takatsuki-shi (JP); Ryuta Kurokawa, Takatsuki-shi (JP); Tadashi Nakatani, Takatsuki-shi (JP); Koji Tanida, Takatsuki-shi (JP); Shintaro Kotake, Takatsuki-shi (JP)

(72) Inventors: Tomoaki Watanabe, Takatsuki-shi (JP); Ryuta Kurokawa, Takatsuki-shi (JP); Tadashi Nakatani, Takatsuki-shi (JP); Koji Tanida, Takatsuki-shi (JP); Shintaro Kotake, Takatsuki-shi (JP)

(73) Assignee: NIPPON INSTRUMENTS CORPORATION, Shibuya-ku, Tokyo (JP)

(21) Appl. No.: 13/988,982

(22) PCT Filed: Oct. 24, 2011
(86) PCT No.: PCT/JP2011/074415

§ 371 Date: May 22, 2013

(30) Foreign Application Priority Data
Nov. 30, 2010 (JP) 2010-266825

(51) Int. Cl. G01N 31/12

(52) U.S. Cl. CPC G01N 31/12
USPC 422/80; 422/78

(57) ABSTRACT

A heating combustion tube 20 of the present invention is used in analysis of mercury in a heated state and includes a sample pyrolysis portion 10 in which a sample S is heated and decomposed, an oxidization portion 11 in which a fourth period metal oxide 13, which is a metal oxide in the fourth period on the periodic table, and a treating portion 12 in which an alkali metal compound and/or an alkali earth metal compound 14 is filled.

### CROSS REFERENCE TO THE RELATED APPLICATION

This application is based on and claims Convention priority to Japanese patent application No. 2010-266825, filed Nov. 30, 2010, the entire disclosure of which is herein incorporated by reference as a part of this application.

### BACKGROUND OF THE INVENTION

1. Field of the Invention

The present invention relates to a heating combustion tube for use in analysis of mercury, which is effective to suppress the interference of coexisting substances tending to be generated at the time of the analysis of mercury in a sample by pyrolysis of the sample, a pyrolysis apparatus equipped with such heating combustion tube, and a mercury analyzing apparatus utilizing such pyrolysis apparatus.

2. Description of Related Art

Hitherto, the mercury analyzing apparatus has been largely employed in the environmental analysis and the quality control analysis for a long time. As the mercury analyzing apparatus, a device utilizing a method of producing the atomic vapor by reduction so far as the analysis of river water is concerned, a device to measure online mercury contained in exhaust gases so far as the analysis of exhaust gases emitted from chimneys of garbage incinerating facilities is concerned (in this respect, see the patent document 1 listed below), and a mercury atomic absorption spectrometer to measure mercury in a sample by pyrolysis of the sample, contained in a sample container, while air is supplied at a predetermined flow rate by an air pump, and then collecting the mercury, generated from the sample, with the use of a mercury collecting tube so far as the solid sample analysis is concerned, are available. At this point, when the sample is pyrolytically decomposed, interfering substances such as, for example, halides and/or sulfides contained in the sample often affect the measurement and, therefore, in the case of a solid sample, the removal of the interfering substances in the sample has been made to pyrolytically decompose the sample, while the sample have been covered with a masking agent or an additive, so that the interfering substances contained in the sample can be adsorbed by the masking agent or the additive, or to passing combustion gases, generated upon heating of the sample, to a scrubbing fluid to allow the interfering substances to be absorbed and removed.

### PRIOR ART LITERATURE

[Patent Document 1] JP Laid-open Patent Publication No. 2001-33434

It has however been found that if the amount of the interfering substances is large, it is quite often that the result of measurement is adversely affected with the interfering substances left unremoved completely and that if the sample is an organic component, the analytical sensitivity tends to be lowered as a result of incomplete combustion with no pyrolysis accomplished sufficiently. Also, in order to relieve the labor incurred in the recent environmental load or measurement, the measurement is desired for with neither the masking agent, the additive nor the scrubbing fluid being used. As discussed above, the analysis of mercury involves a substantial number of problems depending on the sample.

### SUMMARY OF THE INVENTION

In view of the foregoing, the present invention has been devised to substantially eliminate the problems and inconveniences inherent in the prior art techniques and is intended to provide a heating combustion tube for use in analysis of mercury, which is effective to accurately analyze mercury with a high sensitivity by suppressing the interference of coexisting substances with neither the masking agent, the additive nor the scrubbing fluid being used, even though the sample contains a substantial amount of the interfering substances, a pyrolysis apparatus equipped with such heating combustion tube, and a mercury analyzing apparatus utilizing such pyrolysis apparatus.

In order to accomplish the foregoing object, the present invention provides, in accordance with a first aspect thereof, a heating combustion tube for use in analysis of mercury in a heated state, which tube includes a sample pyrolysis portion in which a sample is heated and decomposed, an oxidization portion in which the fourth period metal oxide, which is an oxide of a metal element in the fourth period on the periodic table, is filled, and a treating portion in which an alkali metal compound and/or an alkali earth metal compound is/are filled.

According to the heating combustion tube of the present invention described above, with no need to use any of the masking agent, additive and scrubbing fluid, mercury can be highly sensitively and highly accurately analyzed with the interference of the coexistent substance suppressed.

In the heating combustion tube of the present invention, the sample pyrolysis portion, the oxidization portion and the treating portion are preferably arranged in a linear row sequentially in this order, in which case the use is made of gas permeable separators positioned between the sample pyrolysis portion and the oxidization portion to separate the sample pyrolysis portion and the oxidization portion from each other and between the oxidization portion and the treating portion to separate the oxidization portion and the treating portion from each other. According to this construction, reactions taking place in the various portions can be sufficiently accelerated. In particular, owing to the gas permeable separator positioned between the oxidization portion and the treating portion, the reaction can take place without allowing materials, filled respectively within the oxidization portion and the treating portion, to mix together and, hence, without being affected thereby, and, therefore, mercury can be highly sensitively and highly accurately analyzed.

In the heating combustion tube of the present invention, the fourth period metal oxide is preferably at least one selected from the group consisting of chromium oxide, manganese oxide, cobalt oxide, nickel oxide and copper oxide. During the pyrolysis of the sample, an organic component contained in the sample can be sufficiently oxidized in the presence of those oxides.

In the heating combustion tube of the present invention, the alkali metal compound and/or the alkali earth metal compound is/are preferably at least one selected from the group consisting of oxide, oxide hydroxide and carbonate. During the pyrolysis of the sample, sulfur and halogen both contained in the sample can be sufficiently removed because of those compounds.

In the heating combustion tube of the present invention, a filler material filled in the oxidization portion preferably contains an inorganic binder in a quantity within the range of 0.5 to 50 w % based on the gross weight of the filler material. Since in the presence of the inorganic binder the fourth period metal oxide can be formed to and filled in any desired filling shape such as, for example, pellets, granules or cylinders, the contact area of the organic component in the sample with the fourth period metal oxide can be increased during the pyrolysis of the sample to such an extent as to allow a sufficient oxidization of the organic component to be achieved.

In the heating combustion tube of the present invention, a filler material filled in the treating portion preferably contains an inorganic binder in a quantity within the range of 0.5 to 50 w % based on the gross weight of the filler material. Since in the presence of the inorganic binder the alkali metal compound and/or the alkali earth metal compound can be formed to any desired filling shape such as, for example, pellets, granules or cylinders, the contact area of sulfur and halogen, both contained in the sample, with the alkali metal compound and/or the alkali earth metal compound can be increased during the pyrolysis of the sample to allow the sulfur and halogen to be removed.

In the heating combustion tube of the present invention, a filler material filled in the treating portion preferably contains a compound, which contains as a principal component silicon dioxide and/or alumina, in a quantity within the range of 1 to 70 w % based on the gross weight of the filler material. Thanks to the use of silicon dioxide and/or alumina both used as the principal component, the contact area of a sample gas generated with the alkali metal compound and/or the alkali earth metal compound can be increased during the pyrolysis of the sample to stabilize the flow rate of a carrier gas flowing through the heating combustion tube.

In the heating combustion tube of the present invention, a filler material filled in the treating portion preferably contains a mixture of an inorganic binder with a compound, which contains as a principal component silicon dioxide and/or alumina, in a quantity within the range of 1 to 70 w % based on the gross weight of the filler material. Since the use of the inorganic binder makes it possible for the alkali metal compound and/or the alkali earth metal compound to be formed to and filled in any desired filling shape such as, for example, pellets, granules or cylinders during the pyrolysis of the sample, the contact area of sulfur and halogen, both contained in the sample, with the alkali metal compound and/or the alkali earth metal compound can be increased enough to remove the sulfur and halogen and, also, the use of the compound containing silicon dioxide and/or alumina as the principal component makes it possible to allow the contact area of the sample gas with the alkali metal compound and/or the alkali earth metal compound to be increased during the pyrolysis of the sample enough to stabilize the flow rate of the carrier gas.

The present invention in accordance with a second aspect thereof also provides a pyrolysis apparatus which comprises the heating combustion tube of a structure designed in accordance with the above described first aspect of the present invention, a sample heating furnace to heat the sample pyrolysis portion of the heating combustion tube, an oxidization portion heating furnace to heat the oxidization portion of the heating combustion tube, and a treating portion heating furnace to heat the treating portion of the heating combustion tube. The heating combustion tube referred to above are loaded within the sample heating furnace, the oxidization portion heating furnace and the treating portion heating furnace to allow a mercury gas to be generated as a result of pyrolysis of the sample loaded in the heating combustion tube.

According to the pyrolysis apparatus designed in accordance with the second aspect of the present invention, since the use is made of the heating combustion tube of the structure designed in accordance with the above described first aspect of the present invention, functions and effects similar to those afforded by the heating combustion tube of the structure designed in accordance with the above described first aspect of the present invention can be obtained.

The present invention in accordance with a third aspect thereof also provides a mercury analyzing apparatus to analyze mercury contained in a sample. This mercury analyzing apparatus includes the pyrolysis apparatus of the structure designed in accordance with the above described second aspect of the present invention, a carrier gas flow channel through which a carrier gas flows, a mercury collecting unit to collect the mercury gas generated by the pyrolysis apparatus, a heating and vaporizing furnace to heat the mercury collecting unit to allow the mercury gas to be generated, and an analyzer to determine the content of mercury in the sample.

According to the mercury analyzing apparatus designed in accordance with the third aspect of the present invention, since the use is made of the pyrolysis apparatus designed in accordance with the above described second aspect of the present invention, functions and effects similar to those afforded by the pyrolysis apparatus of the structure designed in accordance with the above described second aspect of the present invention can be obtained.

In the mercury analyzing apparatus according to the third aspect of the present invention, the analyzer is preferably in the form of either an atomic absorption spectrometer or an atomic fluorescence spectrometer. According to this construction, the mercury analyzing apparatus can analyze mercury with a high sensitivity and with a high accuracy.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and: FIG. 1 is a schematic diagram showing a heating combustion tube according to a first embodiment of the present invention, which tube is arranged in a mercury analyzing apparatus according to a second embodiment of the present invention;

FIG. 2 is a schematic diagram showing the heating combustion tube according to the first embodiment of the present invention;

FIG. 3 is a schematic diagram showing a modified form of the heating combustion tube according to the first embodiment of the present invention;

FIG. 4 is a schematic diagram showing an atomic absorption spectrometer employed in the mercury analyzing apparatus according to a second embodiment of the present invention;

FIG. 5 is a schematic diagram showing the mercury analyzing apparatus according to a third embodiment of the present invention; and

FIG. 6 is a schematic diagram showing the atomic fluorescence spectrometer employed in the mercury analyzing apparatus according to the third embodiment of the present invention.

### DESCRIPTION OF PREFERRED EMBODIMENTS

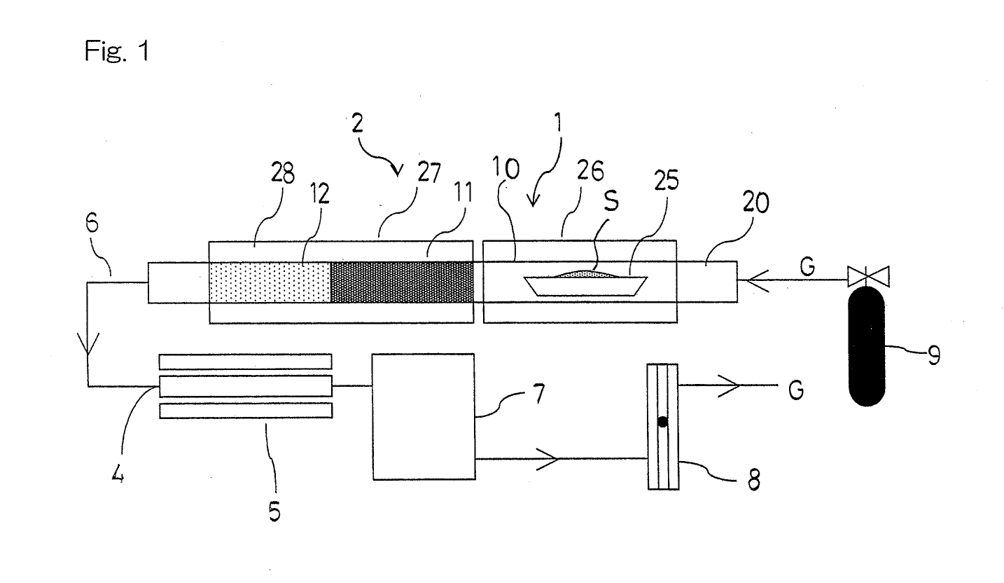

A heating combustion tube designed in accordance with a first embodiment of the present invention will be described in detail. As shown in FIG. 1, the heating combustion tube, generally identified by 20, is loaded in a sample heating furnace 26, an oxidization portion heating furnace 27 and a treating portion heating furnace 28, those heating furnaces are included in a pyrolysis apparatus 2, and the heating combustion tube 20 is heated by each of those heating furnaces for the analysis of mercury. As shown in FIG. 2, the heating combustion tube 20, which is of a tubular shape, has a sample pyrolysis portion 10, in which a sample S is pyrolytically decomposed within the sample heating furnace 26; an oxidization portion 11, in which the fourth period metal oxide 13, i.e., an oxide of a metal element in the fourth period on the periodic table, is filled; and a treating portion 12 in which an alkali metal compound and/or an alkali earth metal compound is/are filled, all of those portions 10, 11 and 12 being arranged in a linear row sequentially in this order. A tube portion 15 of the heating combustion tube 20 is in the form of, for example, a silica tube or a ceramics tube. Preferably, the tube portion 15 includes a wool filling area 21 in the treating portion 12 defined adjacent to a mercury collecting unit 4 and having a filler material such as, for example, a silica wool or rock wool filled therein and is so formed as to represent a shape gradually narrowing from the wool filling area 21 down towards the mercury collecting unit 4.

The fourth period metal oxide 13 is at least one selected from the group consisting of an oxide of chromium, an oxide of manganese, an oxide of cobalt, an oxide of nickel and an oxide of copper. The fourth period metal oxide 13 in the form of a powdery material is filled in the oxidization portion 11 of the heating combustion tube 20 after it has been formed to represent, for example, granules, pellets or cylinders. The alkali metal compound and/or the alkali earth metal compound 14 is/are at least one selected from the group consisting of oxide, oxide hydroxide and carbonate. Those powdery compounds are filled in the treating portion 12 after they has been formed to represent, for example, granules, pellets or cylinders.

The fourth period metal oxide 13 and the alkali metal compound and/or the alkali earth metal compound 14 are filled in the oxidization portion 11 and the treating portion 12, respectively, after they have been mixed with inorganic binders. Specifically, the filler material filled in the oxidization portion 11 preferably contains the inorganic binder in a quantity within the range of 0.5 to 50 w %, preferably 0.5 to 20 w % and more preferably 0.5 to 10 w % based on the gross weight of the filler material. The filler material filled in the treating portion 12 preferably contains the inorganic binder in a quantity within the range of 0.5 to 50 w %, preferably 0.5 to 20 w % and more preferably 0.5 to 10 w % based on the gross weight of the filler material. The inorganic binders referred to above are preferably employed in the form of a material containing, as a principal component, silicon dioxide and/or titanic acid, more specifically, water glass, alkoxysilane, silazane, peroxotitanic acid, etc.

The treating portion 12 is preferably filled with the alkali metal compound and/or the alkali earth metal compound 14 which has/have been mixed with a compound containing, as a principal component, silicon dioxide and/or alumina. The filler material filled in the treating portion 12 contains the compound containing, as a principal component, silicon dioxide and/or alumina in a quantity within the range of 1 to 70 w %, preferably 2 to 60 w % and more preferably 5 to 50 w % based on the gross weight of the filler material. The compound containing, as a principal component, silicon dioxide and/or alumina includes, for example, globular silica, glass beads, ceramics beads, diatomite grains, silica sands, beach sands, and alumina granules.

When the compound, containing silicon dioxide and/or alumina as a principal component, is mixed with the alkali metal compound and/or the alkali earth metal compound 14 and is then filled, the contact area of a sample gas S, generated as a result of the prolysis of the sample S, with the alkali metal compound and/or the alkali earth metal compound 14 can be increased so that the flow rate of a carrier gas to be flown into the heating combustion tube 20 can be stabilized. The weight of the filler material filled in the oxidization portion 11 and the weight of the filler material filled in the treating portion 12 are not necessarily limited to specific values, but are preferably of a substantially equal value.

With respect to the filler material filled in the treating portion 12, a mixture of an inorganic binder with a compound containing, as a principal component, silicon dioxide and/or alumina may be employed in a quantity within the range of 1 to 70 w % based on the gross weight of the filler material. In this case, the mixing ratio between the inorganic binder to be mixed and the compound containing, as a principal component, silicon dioxide and/or alumina is not necessarily limited to a specific value, but it is preferred that the weight of the inorganic binder is not greater than half the weight of the compound containing silicon dioxide and/or alumina as a principal component.

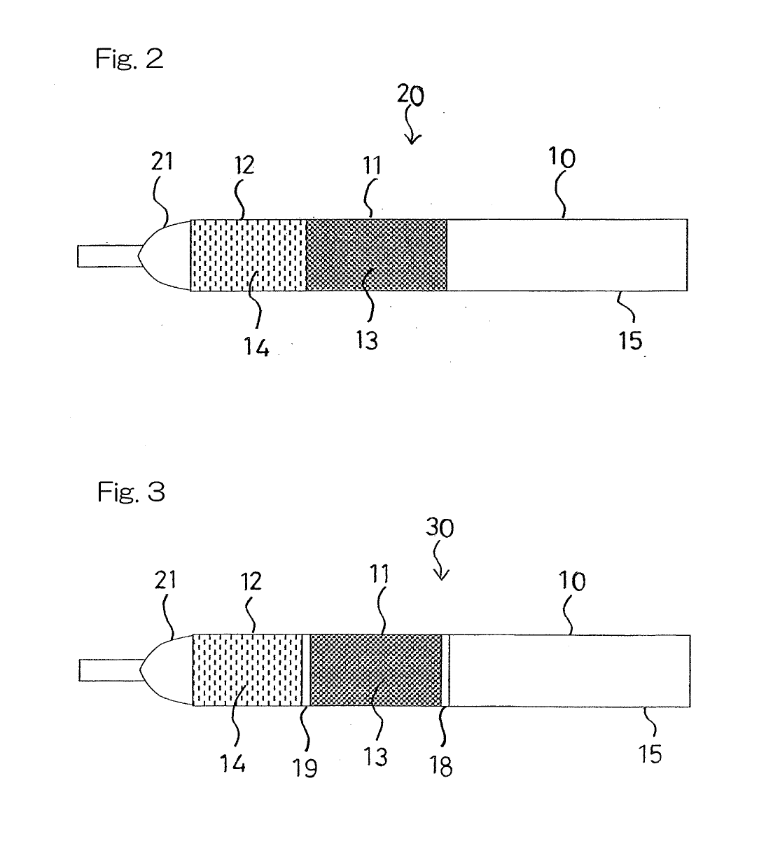

The heating combustion tube, generally identified by 30 and designed in accordance with a modification of the first embodiment of the present invention is, as shown in FIG. 3, provided with a gas permeable separator 18, interposed between the sample pyrolysis portion 10 and the oxidization portion 11, and a gas permeable separator 19 interposed between the oxidization portion 11 and the treating portion 12, such that the sample pyrolysis portion 10 and the oxidization portion 11 are separated from each other by the separator 18 and the oxidization portion 11 and the treating portion 12 are separated from each other by the separator 19. Each of the separators 18 and 19 is employed in the form of a silica filter paper or a ceramics filter paper. Because of the use of the separators 18 and 19, reactions taking place in the various portions can be accelerated. In particular, the fourth period metal oxide 13, filled in the oxidization portion 11, and the alkali metal compound and/or the alkali earth metal compound 14, filled in the treating portion 12, are prevented by the separator 19 from admixing with each other at the boundary and, therefore, the filler materials in those portions 11 and 12 can react with each other efficiently.

Hereinafter, the details of a mercury analyzing apparatus designed in accordance with a second embodiment of the present invention shown in FIG. 1 will be described. The mercury analyzing apparatus 1 includes the pyrolysis apparatus 2 for pyrolytically decomposing the sample S to vaporize mercury, contained in the sample S, to thereby produce a mercury gas, a mercury collecting unit 4 for collecting the mercury gas so produced by the pyrolysis apparatus 2, a heating and vaporizing furnace 5 for heating the mercury collecting unit 4 to produce the mercury gas, a carrier gas supply unit 9 for supplying a carrier gas G that is used to transport the mercury gas so produced, a carrier gas flow channel 6 which is a passage for the flow of the carrier gas G therethrough, a carrier gas control unit 8 for controlling the flow rate of the carrier gas G, and an analyzer 7 to determine the content of mercury in the sample S. The carrier gas G referred to above is allowed to flow from the carrier gas supply unit 9 towards the analyzer 7.

The pyrolysis apparatus 2 referred to above includes a sample container 25 made of, for example, a ceramic material and used to accommodate the sample S such as, for example, coal, mineral ore, activated carbon, fish meat or sea weed, a sample heating furnace 26 for heating the sample pyrolysis portion 10 of the heating combustion tube 20 to pyrolytically decompose the sample S accommodated within the sample container 25, an oxidization portion heating furnace 27 for heating the oxidization portion 11, and a treating portion heating furnace 28 for heating the treating portion 12 and is operable to pyrolytically decompose the sample S to produce the mercury gas. The sample heating furnace 26 is operable to heat the sample pyrolysis portion 10 to a temperature preferably within the range of 500 to 1,000° C. and more preferably within the range of 600 to 900° C. to decompose the sample S. The oxidization heating furnace 27 is operable to heat the oxidization portion 11 to a temperature preferably within the range of 550 to 800° C. to facilitate the oxidative reaction of the oxide filled therein. The treating portion heating furnace 28 is operable to heat the treating portion 12 to a temperature preferably within the range of 350 to 650° C. to facilitate the reaction of the alkali metal compound and/or the alkali earth metal compound 14 filled therein.

As the filler material accommodated within the mercury collecting unit 4, granules or woolen thin lines of gold and/or silver or porous carriers coated with gold and/or silver are employed. The heating and vaporizing furnace 5 referred to above has the mercury collecting unit 4 accommodated within a heating furnace for collecting the mercury generated by the pyrolysis apparatus 2 so that the mercury collecting unit 4 when heated can vaporize the mercury. The carrier gas control unit 8, which is in the form of, for example, a massflow meter, is operable to control the flow rate of the carrier gas G supplied from the carrier gas supply unit 9. The carrier gas supply unit 9 referred to above is a gas cylinder having, for example, a pressure regulating valve fitted thereto. The carrier gas G referred to above is employed mainly in the form of air, oxygen gas or nitrogen gas and argon gas, a neon gas or helium gas may be occasionally employed therefor. In particular, where the sample S containing a substantial amount of organic matters is desired to be pyrolytically decomposed, the oxygen gas is employed for the carrier gas.

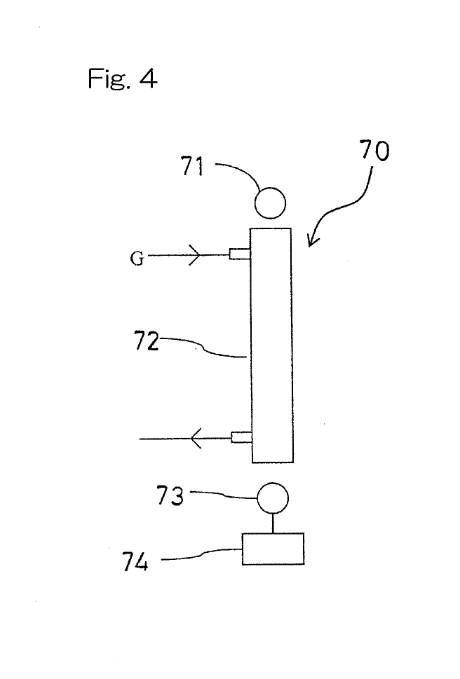

The analyzer 7 referred to above is, for example, an atomic absorption spectrometer such as shown in FIG. 4 and includes a mercury lamp 71 for emitting mercury analytical line rays towards a measurement cell 72 in which the mercury heated and vaporized in the heating and vaporizing furnace 5 is introduced, a detector 73 for detecting the intensity of the mercury analytical line rays which have been passed through the measurement cell 72, and a detection processing unit 74 for calculating the content of mercury in the sample S on the basis of the intensity so detected.

The operation of the mercury analyzing apparatus 1 to measure the sample S of a kind, in which 50 ng of a standard solution of mercury chloride to which 50 mg of a powdery nutritional supplementary food contained 0.5 w % iodine based on the gross weight of the powdery nutritional supplement food has been added, and the result of experiment conducted to determine the rate of recovery of the amount of mercury added will now be discussed. During the experiment, the respective rates of recovery of the amount of mercury were determined and compared, using three, A, B and C heating combustion tubes 30 in which corresponding filler materials of different compositions were filled. Measurement of the above described same sample S was carried out five times to determine the rate of recovery of the amount of mercury.

In respective oxidization portins 11 of the A, B and C heating combustion tubes 30, 98 w % of manganese oxide (the fourth period metal oxide 13) based on the gross weight of the filler material with 2 w % of an inorganic binder of silazane system based on the gross weight of the filler material are mixed together, then molded to form pellets and finally filled.

In the treating portion 12 of the A heating combustion tube 30, sodium carbonate (the alkali metal compound and/or the alkali earth metal compound 14) is filled. In the treating portion 12 of the B heating combustion tube 30, 50 w % of sodium carbonate, based on the gross weight of the filler material, and 50 w % of beach sand (the compound containing silicon dioxide and/or alumina as a principal component) based on the gross weight of the filler material are mixed together and filled. In the treating portion 12 of the C heating combustion tube 30, 95 w % of sodium carbonate 14, based on the gross weight of the filler material, and 5 w % of an inorganic binder of silazane system, based on the gross weight of the filler material, are mixed together, then granulated and filled.

At the outset, the experiment conducted using the A heating combustion tube 30 will be discussed. The sample S is placed within the sample container 30 of a boat-like shape, followed by insertion thereof into the A heating combustion tube 30; the oxygen gas G is supplied from the carrier gas supply unit 9, which is in the form of the oxygen cylinder; while the oxygen gas is supplied at a predetermined flow rate (for example, 0.2 liter/min) by the carrier gas control unit 8, the sample S is gradually heated from room temperature by the sample heating furnace 26 and is heated at a temperature within the range of 500 to 1,000° C. and preferably within the range of 600 to 900° C. to allow the sample S to be pyrolytically decomposed. By so doing, the mercury gas is generated from the sample S. Combustion of the sample S heated within the sample heating furnace 26 is accelerated in the presence of the oxygen gas and the sample gas S containing mercury is, after having been transported by the oxygen gas G through the oxidization portion 11 heated by the oxidization portion heating furnace 27 to a temperature of 700° C., the treating portion 12 heated by the treating portion heating furnace 28 to a temperature of 500° C., and a wool filling area 21, and is then into the mercury collecting unit 4, heated to a temperature within the range of 150 to 250° C., accommodated within a heating furnace of the heating and vaporizing furnace 5 and the mercury is thus collected. During the collection of the mercury, the temperature to which the mercury collecting unit 4 is heated is preferably within the range of 150 to 250° C. so that no other gas than the mercury gas may be collected.

It may occur that while the sample S is pyrolytically decomposed within the sample heating furnace 26, the sample gas S generated within the sample heating furnace 26 may still contain organic components that are left not sufficiently pyrolytically decomposed. When such organic components remaining in the sample gas S are transported to the oxidization portion 11, they may be decomposed into water and carbon dioxide, having been oxidized by the manganese oxide heated to 700° C. Once the organic components remaining in the sample pyrolysis portion 10 are sufficiently pyrolytically decomposed in the oxidization portion 11, they will not be adsorbed by the filler material within the treating portion 12, a mercury collecting material within the mercury collecting unit 4, an inner wall of the carrier gas flow channel 6 and others and, therefore, the analysis can be accomplished at a high sensitivity with a high accuracy without the mercury collection efficiency being lowered.

It is suspected that halogen contained in the sample S exists in the sample gas S, having been transformed into hydrogen halide in the process of the sample S being pyrolytically decomposed and that the hydrogen halide transported by the carrier gas G to the treating portion 12 becomes sodium salt after having been neutralized by heated sodium carbonate. Thus, the halogen existing in the sample is removed from the sample gas S in the presence of the sodium carbonate 14 heated to 500° C. Even though sulfur is contained in the sample S other than the halogen, it can be removed in a similar manner in the treating portion heating furnace 28. Accordingly, since there is no possibility that the halogen and the sulfur may be adsorbed by the inner wall of the carrier gas flow channel 6 and/or the mercury collecting material within the mercury collecting unit 4, the highly sensitive and highly accurate analysis can be accomplished without mercury collection efficiency being lowered.

After the mercury has been collected within the mercury collecting unit 4, the mercury collecting unit 4 within the heating and vaporizing furnace 5 is heated to a temperature within the range of 600 to 800° C. and the vaporized mercury is introduced into a measuring cell 72 of the atomic absorption spectrometer 70 by the carrier gas G at a flow rate of, for example, 0.5 liter/min adjusted by the carrier gas control unit 8 and is then measured. The measuring cell 72, with the mercury gas introduced thereinto in the manner described above, is irradiated with mercury analytical line rays from the mercury lamp 71, and the intensity of mercury analytical line rays, which have passed through the measuring cell 72, is detected by the detector 73, after which the content of mercury in the sample S is calculated by the detection processing unit 74 on the basis of the detected intensity so that mercury in the sample S can be determined.

The measurement using any one of the B heating combustion tube 30 and the C heating combustion tube 30 is carried out in a manner similar to the above described measurement using the A heating combustion tube 30 and, therefore, the details thereof are not reiterated for the sake of brevity.

Results of measurement conducting with the use of the three A, B and C heating combustion tubes 30 are shown in the following table 1. The rate of recovery of mercury obtained after the same sample S has been measured five times was found within the range of 95 to 102% in the case of the A heating combustion tube 30, within the range of 102 to 104% in the case of the B heating combustion tube 30 and within the range of 99 to 103% in the case of the C heating combustion tube 30. Those rates of recovery of mercury exhibited by the respective A, B and C heating combustion tubes 30 were acceptable and, thus, the highly accurate analysis can be accomplished.

TABLE 1

| | | A | B | C | Con- |
|---|---|---|---|---|---|
| | | Heating | Heating | Heating | ventional |
| | | com- | com- | com- | Heating |
| | | bustion | bustion | bustion | combus- |
| | | tube | tube | tube | tion tube |
| Portion 11 | Manganese | 98 w % | 98 w % | 98 w % | |
| | Oxide | | | | |
| | Silazane | 2 w % | 2 w % | 2 w % | |
| | Inorganic | | | | |
| | Binder | | | | |
| | Copper | | | | 100 w % |
| | Oxide | | | | |
| Portion 12 | Sodium | 100 w % | 50 w % | 95 w % | |
| | Carbonate | | | | |
| | Beach | | 50 w % | | |
| | Sand | | | | |
| | Silazane | | | 5 w % | |
| | Inorganic | | | | |
| | Binder | | | | |
| Measurement | Rate of | 95 to | 102 to | 99 to | 0 to |
| Results | Recovery | 102% | 104% | 103% | 90% |

As shown in Table 1 above, the rate of recovery of mercury exhibited when the same sample S as that measured with the mercury analyzing apparatus 1 according to the second embodiment of the present invention was measured five times with the use of the conventional heating combustion tube hitherto used was within the range of 0 to 90%, which shows a considerable dispersion. The conventional heating combustion tube of the conventional mercury analyzing apparatus does not have a treating portion built therein and copper oxide is filled in the oxidization portion. Accordingly, if the sample S contain a substantial amount of halogen, no highly accurate analysis cannot be accomplished with the conventional mercury analyzing apparatus, but the mercury analyzing apparatus 1 according to the second embodiment of the present invention make it possible to accomplish a highly sensitive and highly accurate analysis of mercury with no need to use any masking agent, any additive and any scrubbing fluid and with interference of coexistent substances having been suppressed.

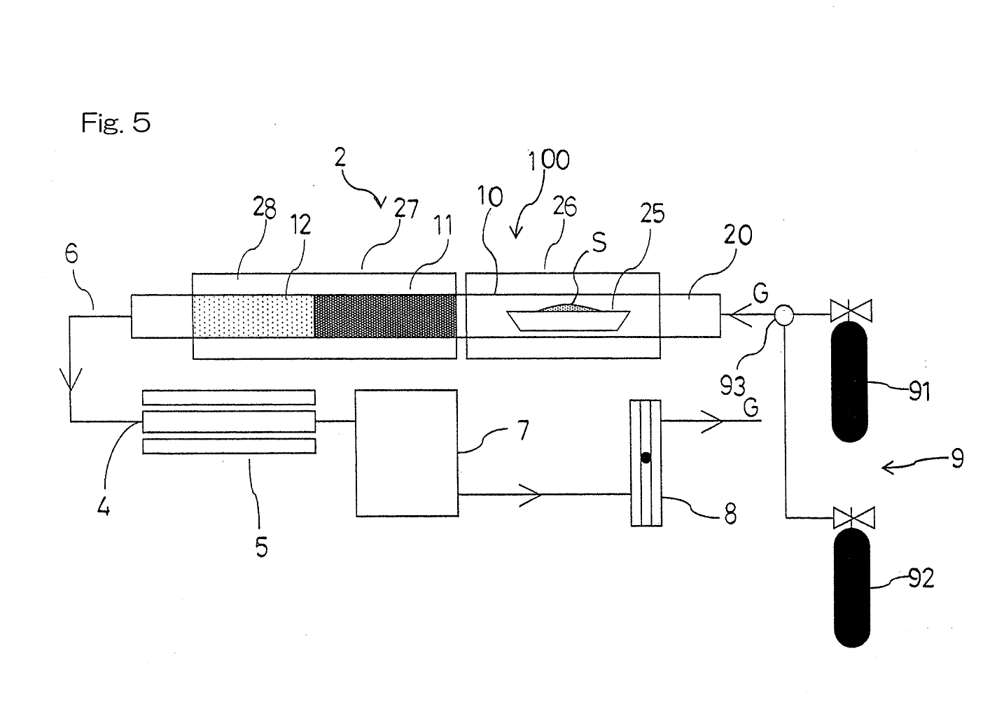

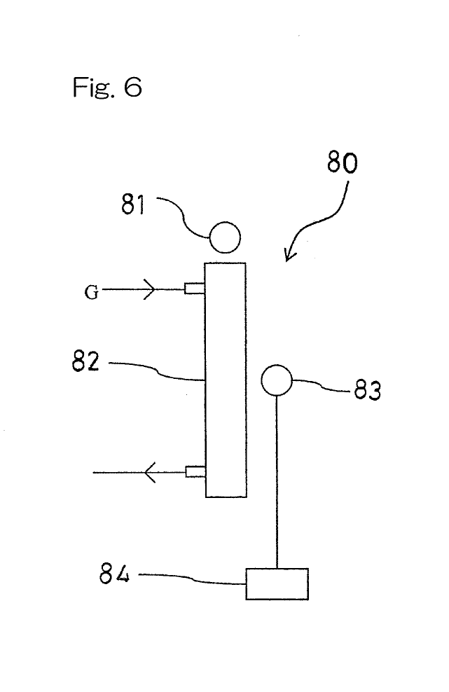

The mercury analyzing apparatus 100 designed in accordance with a third embodiment of the present invention will now be described in detail. Referring to FIG. 5, the mercury analyzing apparatus 100 is similar to the mercury analyzing apparatus 1 according to the previously described second embodiment of the present invention, but differs therefrom in that the analyzer 7 is employed in the form of an atomic fluorescence spectrometer 80, best shown in FIG. 6, rather than the atomic absorption spectrometer 70 best shown in FIG. 4 and employed in the practice of the previously described second embodiment, and, also, the carrier gas supply unit 9 is employed in the form of a device including an oxygen cylinder 91, an argon gas cylinder 92 and a carrier gas switching unit 93 capable of switching one of an oxygen gas and an argon gas over to the other of these gases, the remaining structural features thereof remaining the same as those in the mercury analyzing apparatus 1. As best shown in FIG. 6, the atomic fluorescence spectrometer 80 includes a mercury lamp 81 for emitting mercury analytical line rays towards a measurement cell 82, in which mercury heated and vaporized in the heating and vaporizing furnace 5 is introduced, a detector 83 disposed at a position at which no analytical line ray emitted from the mercury lamp 81 is incident, but at which fluorescence of mercury generated by mercury present in the sample gas S that has been introduced into the measurement cell 82 can be detected, and a detection processing unit 84 for determining the content of mercury in the sample gas S on the basis of the intensity of fluorescence of mercury detected by the detector 83.

The operation of the mercury analyzing apparatus 100 according to the third embodiment of the present invention, ranging from a stage of the pyrolysis of the sample S within the sample heating furnace 26 to a stage of collection of mercury in the sample S, which is done by the mercury collecting unit 4 after passing through the oxidization portion 11 and the treating portion 12, both of the heating combustion tube 20, is similar to that of the operation of the mercury analyzing apparatus according to the previously described second embodiment, except for the oxygen gas employed for the carrier gas G, and, therefore, the details thereof are not reiterated for the sake of brevity. After the mercury has been collected within the mercury collecting unit 4, the carrier gas G is switched from the oxygen gas G over to the argon gas G by the carrier gas switching unit 93 and, therefore, the argon gas G is supplied into the carrier gas flow channel 6. The mercury collecting unit 4 within a heating furnace of the heating and vaporizing furnace 5 is heated to a temperature within the range of 600 to 800° C. and the mercury so vaporized is introduced into the measurement cell 82 of the atomic fluorescence spectrometer 80 by the argon gas G, adjusted to the flow rate of, for example, 0.5 liter/min, and is finally measured. The measurement cell 82, into which the mercury gas is introduced, is irradiated with the mercury analytical line rays emitted from the mercury lamp 81 and, in dependence on the intensity of fluorescence of mercury detected by the detector 83, the content of mercury in the sample gas S is determined by the detection processing unit 84.

According to the mercury analyzing apparatus 100 according to the above described third embodiment of the present invention, functions and effects similar to those afforded by the previously described second embodiment of the present invention can be obtained.

It is to be noted that although in describing each of the second and third embodiments of the present invention, the atomic absorption spectrometer or the atomic fluorescence spectrometer is employed in the form of a wavelength non-dispersion type, but the atomic absorption spectrometer or the atomic fluorescence spectrometer, that can be employed in the practice of the present invention, may be a wavelength dispersion type.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1, 100 Mercury analyzing apparatus

2 Pyrolysis apparatus

4 Mercury collecting unit

5 Heating and vaporizing furnace

6 Carrier gas flow channel

7 Analyzer

10 Sample pyrolysis portion

11 Oxidization portion

12 Treating portion

13 Fourth period metal oxide

14 Alkali metal compound and/or alkali earth metal compound

20, 30 Heating combustion tube

26 Sample heating furnace

27 Oxidization portion heating furnace

28 Treating portion heating furnace

G Carrier gas

S Sample

What is claimed is:

1. A heating combustion tube for use in analysis of mercury in a heated state, which tube comprises:
a sample pyrolysis portion in which a sample is heated and decomposed;
an oxidization portion in which the fourth period metal oxide, which is an oxide of a metal element in the fourth period on the periodic table, is filled; and
a treating portion in which an alkali metal compound and/or an alkali earth metal compound is/are filled.

2. The heating combustion tube as claimed in claim 1, in which the sample pyrolysis portion, the oxidization portion and the treating portion are arranged in a linear row sequentially in this order, and further comprising:
gas permeable separators positioned between the sample pyrolysis portion and the oxidization portion to separate the sample pyrolysis portion and the oxidization portion from each other and between the oxidization portion and the treating portion to separate the oxidization portion and the treating portion from each other.

3. The heating combustion tube as claimed in claim 1, in which the fourth period metal oxide is at least one selected from the group consisting of chromium oxide, manganese oxide, cobalt oxide, nickel oxide and copper oxide.

4. The heating combustion tube as claimed in claim 1, in which the alkali metal compound and/or the alkali earth metal compound is/are at least one selected from the group consisting of oxide, oxide hydroxide and carbonate.

5. The heating combustion tube as claimed in claim 1, in which a filler material filled in the oxidization portion contains an inorganic binder in a quantity within the range of 0.5 to 50 w % based on the gross weight of the filler material.

6. The heating combustion tube as claimed in claim 1, in which a filler material filled in the treating portion contains an inorganic binder in a quantity within the range of 0.5 to 50 w % based on the gross weight of the filler material.

7. The heating combustion tube as claimed in claim 1, in which a filler material filled in the treating portion contains a compound, which contains as a principal component silicon dioxide and/or alumina, in a quantity within the range of 1 to 70 w % based on the gross weight of the filler material.

8. The heating combustion tube as claimed in claim 1, in which a filler material filled in the treating portion contains a mixture of an inorganic binder with a compound, which contains as a principal component silicon dioxide and/or alumina, in a quantity within the range of 1 to 70 w % based on the gross weight of the filler material.

9. A pyrolysis apparatus which comprises:
the heating combustion tube as defined in claim 1;
a sample heating furnace to heat the sample pyrolysis portion of the heating combustion tube;
an oxidization portion heating furnace to heat the oxidization portion of the heating combustion tube; and
a treating portion heating furnace to heat the treating portion of the heating combustion tube;
the heating combustion tube being loaded within the sample heating furnace, the oxidization portion heating furnace and the treating portion heating furnace to allow a mercury gas to be generated as a result of pyrolysis of the sample loaded in the heating combustion tube.

10. A mercury analyzing apparatus to analyze mercury contained in a sample, which apparatus comprises:
the pyrolysis apparatus as defined in claim 9;
a carrier gas flow channel through which a carrier gas flows;
a mercury collecting unit to collect the mercury gas generated by the pyrolysis apparatus;
a heating and vaporizing furnace to heat the mercury collecting unit to allow the mercury gas to be generated; and
an analyzer to determine the content of mercury in the sample.

11. The mercury analyzing apparatus as claimed in claim 10, in which the analyzer comprises an atomic absorption spectrometer or an atomic fluorescence spectrometer.
